(19) United States
(12) Patent Application Publication
(10) Pub. No.: US 2010/0294063 A1
(43) Pub. Date: Nov. 25, 2010

(54) FRICTION DAMPED GEARS

(75) Inventors: James G. Schroth, Troy, MI (US); Ronald M. Leachman, Commerce Township, MI (US); John E. Carsley, Clinton Township, MI (US); Shung H. Sung, Troy, MI (US)

Correspondence Address: General Motors Corporation;c/o REISING ETHINGTON P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/470,647

(22) Filed: May 22, 2009

(51) Int. Cl. F16H 55/14

(52) U.S. Cl. 74/411

(57) ABSTRACT

One exemplary embodiment includes a transfer gear that carries a friction damping component that damps vibrations in the gear. The friction damping component may be carried on or in a hub, a web, or both the hub and the web, and may include at least one non-bonded surface that contacts an adjacent surface.

### TECHNICAL FIELD

The technical field of this disclosure generally relates to gears and methods of making and using the same.

### BACKGROUND

Gears are utilized in many everyday machines for transmitting rotational forces between shafts at different speeds, torques, and/or in different directions. While doing so, an individual gear or a multitude of gears may oftentimes experience and transmit vibrations as a result of interactions with other components like a neighboring meshed gear or a rotating shaft. One type of an adverse effect that ensues from these kinds of vibrations is a tendency of the gears or associated components to emit noise at objectionable levels.

Efforts have thus been made with varying degrees of success to try and diminish the occurrence of vibrations and noise in the many gears utilized throughout a vehicle's powertrain. Nonetheless, it is still desirable in terms of mechanical performance and listening comfort to try and reduce vibration propagation within gears and ultimately lessen the noise produced by a vehicle's individual gears, gear train, and transmission.

### SUMMARY OF EXEMPLARY EMBODIMENTS

One exemplary embodiment includes a product including a transfer gear for use in a vehicle that may have a hub, a web, a plurality of gear teeth, and a friction damping component carried by the hub, the web, or both the hub and the web. The friction damping component may have at least one non-bonded surface that contacts an adjacent surface and damps vibrations in the gear.

Another exemplary embodiment includes a product including a transfer gear for use in a vehicle that may include a hub that defines a cavity delimited by at least one internal surface of the hub. A friction damping component may include at least one non-bonded outer surface that contacts the at least one internal surface of the hub and damps vibrations in the gear. A sealer may seal the friction damping component in the cavity and protect the at least one non-bonded surface against exposure to lubricant fluids.

Yet another exemplary embodiment includes a product including a transfer gear for use in a vehicle that may include a web that extends radially from a hub and includes at least one face. A friction damping component may include at least one non-bonded surface that contacts the at least one face of the web and damps vibrations in the gear. The friction damping component may further be fastened to the face by one or more joints that protect the non-bonded surface against exposure to lubricant fluids.

Still another exemplary embodiment includes a method including disposing a friction damping component in or on a hub, a web, or a hub and a web of a gear for use in a vehicle.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a cross-sectional view of the transfer gear according to one embodiment of the invention.

FIG. 1A is a magnified view of the encircled portion of the transfer gear shown in FIG. 1 according to one embodiment of the invention.

FIG. 2 is a cross-sectional view of a transfer gear according to one embodiment of the invention

FIG. 2A is a magnified view of the encircled portion of the transfer gear shown in FIG. 2 according to one embodiment of the invention.

FIG. 2B is a magnified view of the encircled portion of the transfer gear shown in FIG. 2 according to one embodiment of the invention.

### DETAILED DESCRIPTION OF EXEMPLARY EMBODIMENTS

The following description of the embodiment(s) is merely exemplary in nature and is in no way intended to limit the invention, its application, or uses.

Before referring to the drawings, it should be noted that motor vehicles utilize a wide variety of gears in combination to transmit power from the vehicle's engine through a differential and eventually to its axles. To transfer speed and torque from one axis to another, for example, in a power transmission or transfer case, at least one relatively large diameter and load-bearing gear commonly referred to as power transfer gear may be utilized. These gears are highly-stressed when in operation and are often loaded in multiple directions when at rest. It is for these and other reasons that power transfer gears are generally forged from blanks at exceedingly high pressures and then heat-treated by carburization or some other adequate heat-treatment in order to attain the highest feasible strength and durability possible. These and other similarly forged gears may nonetheless be provided with a friction damping component following the forging process. The friction damping component helps damp vibrations experienced by the gear whenever vibrations or other modal excitements are imparted to the gear such as, for example, when the gear is installed and operating in conjunction with other contacting components in a vehicle.

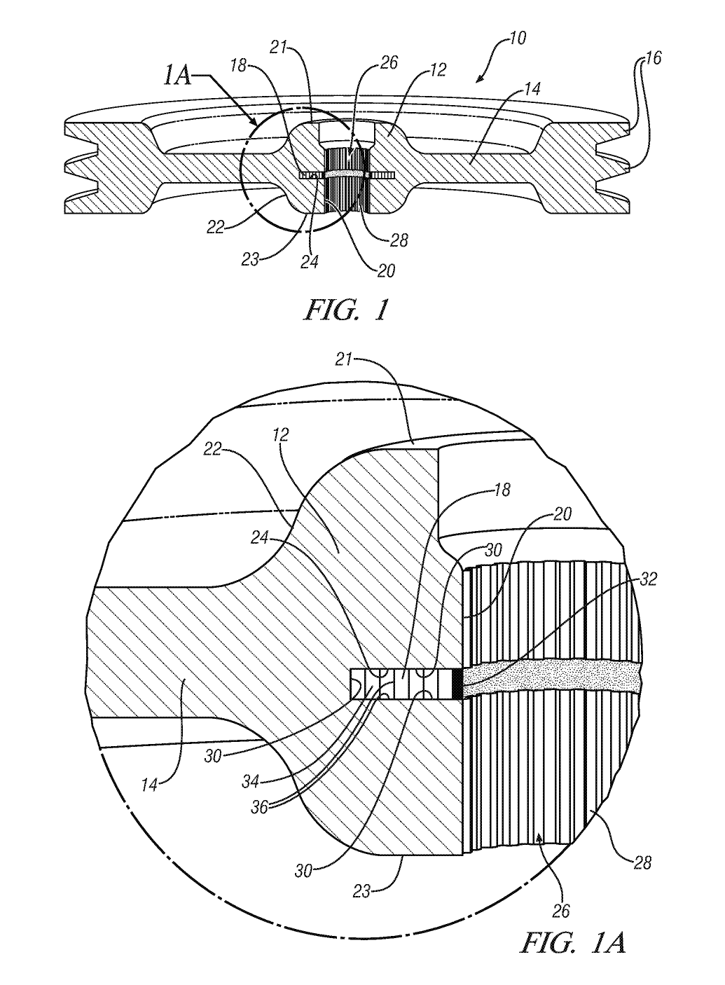

Referring in more detail to the drawings, FIGS. 1-1A show an exemplary embodiment of a power transfer gear that exhibits vibration damping characteristics. In one exemplary embodiment, as shown, the gear may be a forged power transfer gear 10 that generally includes a hub 12, a web 14 extending radially from the hub 12, a plurality of teeth 16 disposed circumferentially around the web 14 for meshing with an adjacent gear, and at least one friction damping component 18 carried by the hub 12.

The hub 12 generally allows for operative engagement with a shaft (not shown) that drives or is driven by the gear 10. The hub 12 may be configured in any known manner but is shown here as including an inner cylindrical surface 20, an outer exterior surface 22 that transitions into the web 14 near the center of the hub 12, and at least one cavity 24. The inner cylindrical surface 20 defines an opening 26 for receiving the shaft and may provide the hub 12 with an axial thickness greater than that of the web 14 if the magnitude of power transferred between the hub 12 and the shaft so requires. To further aid in such power transfer, the inner cylindrical surface 20 may encompass a plurality of teeth 28 circumferentially spaced around the opening 26. The plurality of teeth 28 may facilitate engagement between the hub 12 and a correspondingly splined portion of the shaft and may further promote uninterrupted power transfer therebetween by decreasing the probability that slip will occur.

The cavity 24 may be defined in the hub for receiving the friction damping component 18. The cavity 24 may extend radially into the hub 12 and be delimited by at least one internal surface 30—an internal surface is one located within the general boundaries of the hub such as somewhere between the inner cylindrical surface 20 and the outer exterior surface 22. It is also possible for multiple cavities of similar or dissimilar configurations to be formed in the hub 12.

Here, as shown in this particular embodiment, the cavity 24 may be continuously circumferentially formed into the inner cylindrical surface 20 around the opening 26. Thus, it may be delimited by three internal surfaces 30 of the hub 12 and be accessible through the inner cylindrical surface 20. The cavity 24 may also extend radially into the hub 12 about half-way or a little further than half-way to the outer exterior surface 22. The precise extent to which the cavity 24 is formed in the hub 12, for example its radial depth and/or its axial width, may be chosen or calculated so as to not unnecessarily weaken the gear 10 and diminish its load-bearing capacity. And while these dimensions are generally known or discoverable through experience to skilled artisans, the cavity 24 depicted here has an approximate axial thickness of about 2 mm and an approximate radial depth of about 15 mm. An appropriate post-forging machining operation may be used to controllably form the cavity to these or other desired dimensions.

It should be noted, however, that the cavity 24 may be defined in the hub 12 in configurations other than that just described. For example, the cavity may be discontinuous. In such an alternative configuration the cavity may comprise many smaller and discontinuous arcuate cavities formed circumferentially around the opening 26 to closely resemble the continuous cavity 24 described earlier. The cavity may also be formed spirally around the opening 26, or straight along the opening 26 in the axial direction in conjunction with other similar cavities that are circumferentially spaced apart around the opening 26. Furthermore, multiple similar cavities or a combination thereof may be formed in the hub 12. And still further the cavity or multiple cavities may be formed in the hub 12 at a location other than the inner cylindrical surface 20—i.e., through the outer exterior surface 22 or axially into the hub 12 from an axial top surface 21 or an axial bottom surface 23 of the hub 12.

The friction damping component 18 includes at lease one non-bonded surface that dampens vibrations in the gear by facilitating some type of relative frictional movement capable of converting the mechanical energy responsible for the vibrations into thermal energy which is easily dissipated to the surrounding environment. That is, the non-bonded surface is characterized by its ability to experience relative movement with an adjacent contacting surface(s) and to resist binding or sticking thereto under normal and extensive gear operating conditions.

The exact construction of the friction damping component 18 is amenable to variation, and may include constructions where the non-bonded surface constitutes an internal or external surface of the friction damping component 18, or both. Protection of the non-bonded surface against exposure to transmission fluids, such as automatic transmission fluids, may also be advisable in some instances as these fluids are often typified by a low coefficient of friction and can thus hamper or even significantly disrupt the effectiveness of the friction damping component 18.

The non-bonded surface of the friction damping component 18 can be fabricated in a multitude of fashions and, as such, a few examples are briefly described. For instance, the non-bonded surface may exist due to a rough or uneven surface contour as exemplified by a host of peaks and valleys. The average depth of the valleys (or height of the peaks) may range from about 1 μm to about 300 μm, and usually ranges from about 50 μm to 260 μm or from about 100 μm to 160 μm. A friction damping component 18 exhibiting such a rough or uneven surface contour helps ensure that meaningful frictional engagement can occur with an opposed or adjacent contacting surface, whether smooth or roughened as well, when vibrations are imparted to the gear. The rough or uneven surface contour may be fostered by a surface deformation technique such as shot-peening, etching, sand-blasting, water jet blasting, glass bead blasting, or any other known surface modification process capable of producing a similar affect. The non-bonded surface may also exist due to imbedded or bonded particles whose presence similarly promotes meaningful frictional contact with an opposed or adjacent contacting surface. The particles may be irregularly shaped and formed of refractory materials such as, for example, silica, alumina, graphite with clay, silicon carbide, silicon nitride, cordierite, mullite, zirconia, or phyllosilicates. The particles may also be formed from other appropriate materials such as, for example, non-refractory polymeric materials, ceramics, composites, or wood. To form a non-bonded surface with particles, a simple compressive force may suffice to directly imbed the particles into the friction damping component, or the particles may be carried by a coating applied to the friction damping component. The coating may include any suitable binder such as, but not limited to, epoxy resins, phosphoric acid binding agents, calcium aluminate cements, wood flour, clays, or a lignosulfonate binder such as calcium lignosulfonate. One specific example of a coating that can facilitate a non-bonded surface is IronKote, which is available from Vesuvius Canada Refractories, Inc., of Welland, Ontario. IronKote is composed of alumina particles (about 47.5%) and silicate particles (about 39.8%) dispersed in a lignosulfonate binder. While the thickness of the applied coating may vary depending on, among others, the compositional makeup of the coating and the environment to which the coating may be exposed, it usually ranges from is about 1 μm to about 400 μm.

In the specific exemplary embodiment shown in FIGS. 1-1A, the friction damping component 18 may comprise a strand 34—such as a wire or filament—that includes a non-bonded surface 36 for contacting the at least one internal surface 30 of the hub 12. The strand 34 may be sized and shaped so that it can be cozily received in the cavity 24 to help encourage intimate contact between the outer non-bonded surface 36 and the at least one internal surface 30 in all directions. In one embodiment, the strand 34 may be inserted circumferentially into the cavity 24 in a layered-fashion. This may involve, for example, introducing one end of the strand 34 into the cavity 24 and then progressively coiling the remainder of the strand 34 circumferentially around the cavity 24 until it occupies a predetermined amount of the cavity's 24 radial depth. Such a layered configuration of the strand 34 not only allows the outer non-bonded surface 36 of the strand 34 to frictionally interact with the internal surfaces 30 of the hub 12, but also allows it to frictionally interact with itself as between adjacent layered portions of the strand 34. Moreover, mechanically compacting the strand 34 in the radial direction during insertion helps ensure that a sufficient quantity is received in the cavity 24 so that it can effectively contribute to damping vibrations in the gear 10. In some instances the strand 34 may be inserted so as to occupy all or substantially all of the radial depth of the cavity 24. But in other instances the strand 34 may be inserted to only partially occupy the cavity 24.

Of course, the friction damping component 18 may constitute other structures and designs besides the strand 34 just described. For instance, the friction damping component 18 may constitute material that does not have to be wound into the cavity 24 but can instead be systematically packed therein. Examples of alternative friction damping components 18 include, but are not limited to, pre-fabricated ring inserts, loose particles, and arcuate shaped inserts.

A sealer 32 may be employed that seals the friction damping component 18 in the cavity 24 and protects the non-bonded surface 36 of the friction damping component 18 against exposure to lubricant fluids such as, for example, transmission fluids. As shown in this embodiment, the sealer 32 may completely seal the cavity 24 and cause the friction damping component 18 to be entirely enclosed and protected therein. The sealer 32 may be of any type known to skilled artisans that can accomplish its intended purposes under gear operating conditions. For example, the sealer 32 may be a high-temperature resistant material such as a silicon sealant or an anaerobic adhesive. As another example, the sealer 32 may be the product of a localized brazing operation in which a filler metal, such as a silver alloy, fuses the cavity 24 shut while the gear 10 is being carburized or otherwise heat-treated.

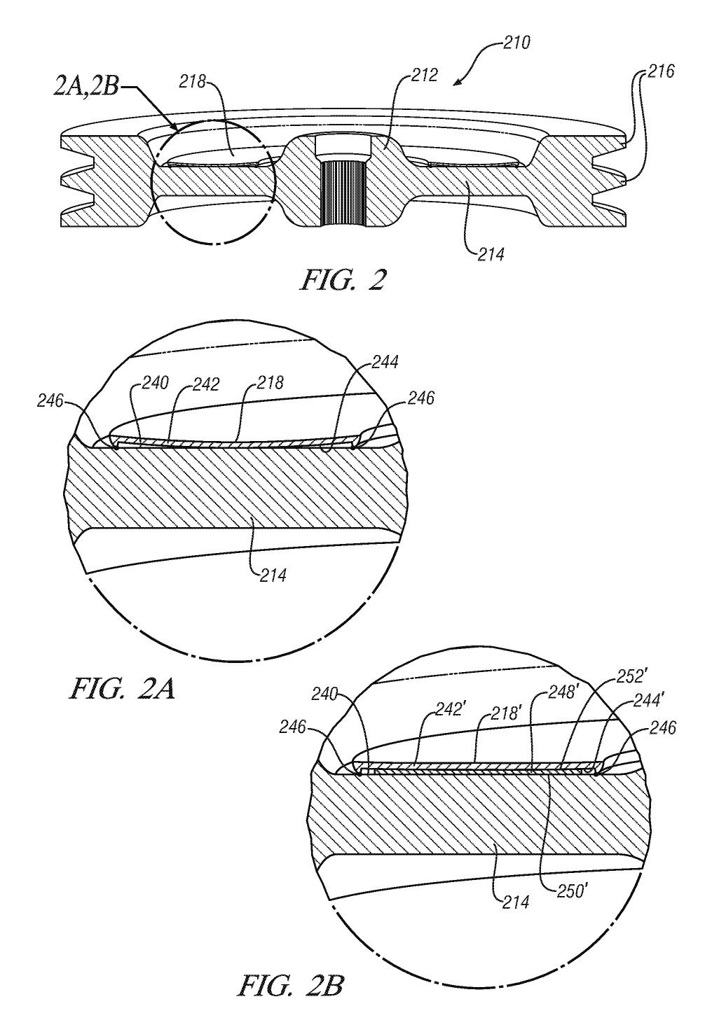

Referring now to FIGS. 2-2B, there are shown second and third exemplary embodiments of a power transfer gear 210 that exhibits vibration damping characteristics. The embodiments described here may be employed separately, together, and/or in conjunction with the previously-described embodiments. The gear 210 shown and described is similar in many respects to the embodiment shown in FIGS. 1-1A in that it generally includes a hub 212, a web 214 extending radially from the hub 212, a plurality of teeth 216 disposed circumferentially around the web 214 for meshing with an adjacent gear, and a friction damping component 218. At least one difference here is that a friction damping component 218 is carried on or in the web 214.

The web 214 unites the hub 212 with the plurality of teeth 216 and generally provides the structural support necessary to ensure collaboration therebetween. The web 214 may span continuously annularly between the hub 212 and the plurality of teeth 216 without interruption, as shown, or it may include one or more holes or passageways that separate the web 214 into smaller links for purposes primarily aimed at mass reduction. The web 212 may include a face 240 that generally represents any accessible exterior surface of the web 214. Here, the face 240 may be a substantially flat exterior surface integrally and annularly formed from the hub 212 to the plurality of gear teeth 216—thus facing in a direction parallel to the axis of the gear 210. The opposite side of the web 214 also has a similarly situated face.

In the exemplary embodiment shown in FIG. 2A, the friction damping component 218 may constitute a plate 242 having a non-bonded bottom surface 244 that contacts the face 240 of the web 214. The plate 242 may assume any geometric configuration but is shown here as being annular in shape and nearly coextensive with the face 240 of the web 214. In other embodiments, however, the plate 242 may be annularly shaped and sized to have a radial dimension that overlies about 10 percent to about 80 percent of the radial dimension of the face 240. The plate 242 may be formed from metallic sheet materials including, but not limited to, steel and aluminum alloys. Other possible geometric shapes that the plate may embody include those adapted for gears having a discontinuous web due to the presence of one or more holes, passageways, or other design features attributable to functional and/or aesthetic purposes.

The plate 242 may be bowed or otherwise manipulated so that the non-bonded bottom surface 244 contacts and is biased against the face 240 of the web 214. The biasing force provided by the plate 242 may be chosen so that an appropriate amount of relative frictional contact can occur between the non-bonded bottom surface 244 and the face 240 during gear 210 operating conditions; that is, the non-bonded bottom surface 244 may be biased against the face 240 with a force sufficient to keep the two surfaces 244, 240 firmly pressed together while still allowing for some relative frictional movement to occur therebetween when the gear 210 is vibrated or excited. And much like the previous embodiments, the frictional interaction experienced between the non-bonded bottom surface 244 and the face 240 of the web 214 may help damp the gear 210 and suppress the transmission of noise attributable to vibration propagation in the gear 210.

The plate 242 may be fastened to the face 240 by one or more joints 246 that protect the non-bonded bottom surface 244 against exposure to lubricant fluids such as, for example, transmission fluids. As shown here, the non-bonded bottom surface 244 may be bordered by a pair of radially spaced incessant annular joints 246 that can isolate the non-bonded bottom surface 244 from the surrounding environment and ultimately preserve its capabilities. Also, to aid in effectively damping vibrations in the gear 210, the radial distance between the joints 246 may be maximized to the largest extent feasible to ensure enough meaningful frictional contact can occur between the non-bonded bottom surface 244 of the plate 242 and the face 240 of the web 214. The one or more joints 246 may be formed by welding the plate 242 to the face 240 after the gear 210 is forged into shape. For example, the joints 246 may be formed by a capacitive-discharge welding operation. Also, it should be understood that the embodiment just described may be implemented in like fashion on the opposite side of the gear as well, if desired.

In another exemplary embodiment, as shown in FIG. 2B, the friction damping component 218′ may include a plate 242′ similar to that already described and an intermediate damping material 248′ between the plate 242′ and the face 240 of the web 214. The intermediate damping material 248′ may assume a variety of constructions. For example, as depicted in FIG. 2B, the intermediate damping material 248′ may be in the shape of an annular ring or washer that includes a first non-bonded surface 250′ that is pressed against the face 240 of the web 214 by the downward biasing force of the plate 242′. The intermediate damping material 248′ shown may also include a second non-bonded surface 252′ that is acted upon by the non-bonded bottom surface 244′ of the plate 242′, if desired. The combined frictional interactions that may occur at the first and second non-bonded surfaces 250′, 252′ of the intermediate damping material 248′ can thus provide a helpful damping effect to the gear 210 when it is vibrated.

The intermediate material may be fabricated from metallic sheet materials such as steel or aluminum, metallic sheet materials coated with a suitable particulate-containing coating, or metallic or ceramic fibrous materials such as felts, wools, and/or fabrics. Other possible constructions for the intermediate damping material 248′—besides the washer or ring shape just described and shown in FIG. 2B—include a collection of loose individual pieces of packing material in palletized or granule form. Each of the pieces of packing material may include an outer non-bonded surface for generating frictional interactions between themselves, with the face 240 of the web 214, and with the non-bonded bottom surface 244′ of the plate 242′ to help damp the gear 210.

The above description of embodiments of the invention is merely exemplary in nature and, thus, variations thereof are not to be regarded as a departure from the spirit and scope of the invention.

What is claimed is:

1. A product comprising:
a transfer gear for use in a vehicle comprising:
a hub;
a web that extends radially from the hub;
a plurality of teeth circumferentially disposed around the web; and
a friction damping component carried by the hub, carried by the web, or carried by both the hub and the web, and wherein the friction damping component includes at least one non-bonded surface that contacts an adjacent surface and damps vibrations in the gear.

2. The product of claim 1, wherein the at least one non-bonded surface is protected against exposure to transmission fluids.

3. The product of claim 1, wherein the friction damping component is disposed in a cavity defined in the hub and sealed therein by a sealer.

4. The product of claim 3, wherein the hub includes an inner cylindrical surface that defines an opening and a cavity extending radially into the hub from the inner cylindrical surface and being delimited by at least one internal surface of the hub, and wherein the friction damping component is a strand that includes a non-bonded outer surface that, when the strand is wound into the cavity, contacts the at least one internal surface of the hub.

5. The product of claim 3, wherein the sealer is an adhesive.

6. The product of claim 1, wherein the web comprises a face, and the non-bonded surface of the friction damping component contacts the face of the web.

7. The product of claim 6, wherein the friction damping component comprises a plate that has a non-bonded bottom surface, the plate being fastened to the face of the web by one or more joints.

8. The product of claim 7, wherein the non-bonded bottom surface of the plate contacts and is biased against the face of the web.

9. The product of claim 7, wherein the friction damping component further comprises an intermediate damping material that comprises a first non-bonded surface that contacts the face of the web and is pressed against the face of the web by the plate.

10. The product of claim 9, wherein the intermediate damping component further comprises a second non-bonded surface that is acted upon by the non-bonded bottom surface of the plate.

11. The product of claim 7, wherein the plate is annular in shape and includes a first joint at an inner annular end and a second joint at an outer annular end.

12. The product of claim 7, wherein the one or more joints are formed by welding.

13. A product comprising:
a transfer gear for use in a vehicle comprising:
a hub that defines a cavity delimited by at least one internal surface of the hub;
a friction damping component that includes at least one non-bonded outer surface that contacts the at least one internal surface of the hub and damps vibrations in the gear; and
a sealer that seals the friction damping component in the cavity and protects the at least one non-bonded outer surface against exposure to lubricant fluids.

14. The product of claim 13, wherein the hub includes an inner cylindrical surface that defines an opening and wherein the cavity extends radially into the hub from the inner cylindrical surface.

15. The product of claim 13, wherein the friction damping component is a strand that includes a non-bonded outer surface that, when inserted into the cavity, contacts the at least one internal surface.

16. The product of claim 13, wherein the sealer is an adhesive.

17. A product comprising:
a transfer gear for use in a vehicle comprising:
a hub;
a web that extends radially from the hub and includes at least one face;
a friction damping component that includes at least one non-bonded surface that contacts the at least one face and damps vibrations in the gear; and
one or more joints that fasten the friction damping component to the gear and protect the non-bonded surface against exposure to lubricant fluids.

18. The product of claim 17, wherein the friction damping component comprises an annular plate having a non-bonded bottom surface that contacts and is biased against the at least one face of the web, the annular plate being fastened to the web by a pair or radially spaced incessant annular joints that are formed by welding.

19. The product of claim 17, wherein the friction damping component comprises an annular plate having a non-bonded bottom surface and an intermediate damping material disposed between the non-bonded surface of the annular plate and the face of the web, the intermediate damping material having at least one non-bonded surface that is pressed against the face of the web by a biasing force of the annular plate, the annular plate being fastened to the web by a pair or radially spaced incessant annular joints that are formed by welding

20. The product of claim 19, wherein the intermediate damping material comprises an annular washer that has a first non-bonded surface that is pressed against the face of the web and a second non-bonded surface that is acted upon by the non-bonded bottom surface of the annular plate.

21. A method comprising:
providing a transfer gear that includes a hub, a web extending radially from the hub, and a plurality of gear teeth circumferentially disposed around the web;
providing a friction damping component that includes at least one non-bonded surface; and
disposing the friction damping component in or on the hub, the web, or the hub and the web;
causing to power transfer gear to be vibrated so that frictional contact between the at least one non-bonded surface and the adjacent surface damps vibrations in the gear.

22. The method of claim 21 further comprising:
protecting the at least one non-bonded surface of the friction damping component from exposure to lubricant fluids.
